(19) United States
(12) Patent Application Publication
(10) Pub. No.: US 2026/0304197 A1
(43) Pub. Date: Oct. 1, 2026

(54) METHOD FOR PREDICTING AND CONTROLLING TRAFFIC PATTERNS IN A USER PLANE, AND DEVICES PERFORMING THE SAME

(71) Applicant: Electronics and Telecommunications Research Institute, Daejeon (KR)

(72) Inventors: Jonggwan AN, Daejeon (KR); Myung Ki SHIN, Seoul (KR)

(73) Assignee: Electronics and Telecommunications Research Institute, Daejeon (KR)

(21) Appl. No.: 19/632,579

(22) Filed: Mar. 30, 2026

(30) Foreign Application Priority Data
Mar. 28, 2025 (KR) 10-2025-0040047
Mar. 28, 2025 (KR) 10-2025-0040049
Mar. 28, 2025 (KR) 10-2025-0040053
May 9, 2025 (KR) 10-2025-0060158
May 9, 2025 (KR) 10-2025-0060159
May 9, 2025 (KR) 10-2025-0060160
Aug. 14, 2025 (KR) 10-2025-0112781
Aug. 14, 2025 (KR) 10-2025-0112782
Aug. 14, 2025 (KR) 10-2025-0112783
Oct. 2, 2025 (KR) 10-2025-0145177
Oct. 2, 2025 (KR) 10-2025-0145180
Oct. 2, 2025 (KR) 10-2025-0145184
Nov. 6, 2025 (KR) 10-2025-0166137
Nov. 6, 2025 (KR) 10-2025-0166138
Nov. 6, 2025 (KR) 10-2025-0166139
Nov. 6, 2025 (KR) 10-2025-0166140
Nov. 6, 2025 (KR) 10-2025-0166141
Nov. 6, 2025 (KR) 10-2025-0166142
Mar. 26, 2026 (KR) 10-2026-0054872

(51) Int. Cl. H04W 24/10; H04W 24/08

(52) U.S. Cl. CPC H04W 24/10; H04W 24/08

(57) ABSTRACT

A method of predicting and controlling a traffic pattern in a user plane and devices for performing the same are provided. The method includes receiving a request for analytics of abnormal user plane traffic from a consumer network function (NF), collecting data for the analytics of the abnormal user plane traffic from a fifth generation core (5GC) NF, generating analytics information on the abnormal user plane traffic based on the collected data, and transmitting the analytics information to the consumer NF, and the analytics information includes one of statistical information and prediction information associated with control of the abnormal user plane traffic.

### TECHNICAL FIELD

The following description relates to a method of predicting and controlling a traffic pattern in a user plane and devices for performing the same.

### BACKGROUND OF THE INVENTION

A fifth generation (5G) mobile communication system defines a network data analytics function (NWDAF) that is a network function for analyzing and providing data collected from a 5G network to support network automation.

For automation and optimization of the 5G mobile communication system, the NWDAF builds big data by collecting a function of each network and raw data of an application function and provides network analytics information by processing the big data.

In a user plane of a mobile communication system, data communication is performed via uplink and downlink based on a static rule. For burst-heavy service requirements, such as an Internet-of-Things (IoT) device, an over-the-top (OTT) service, and mixed reality (XR)/augmented reality (AR), in which traffic is irregular, frequently changes (e.g., non-linear, highly variable), and may burst (surge) more than hundreds of gigabits per second (Gbps) at one second, a static rule may be insufficient to predict and control and may lead to user plane performance degradation.

The above description has been possessed or acquired by the inventor(s) in the course of conceiving the present disclosure and is not necessarily an art publicly known before the present application is filed.

### DISCLOSURE OF THE INVENTION

### Technical Goals

An embodiment may provide a method of predicting and controlling traffic that has a traffic pattern (e.g., non-linear, high variability, or burstiness) that is difficult to predict and occurs due to a static rule in a user plane through learning and analyzing a behavior and a pattern of the user plane.

An embodiment may provide improved resilience and robustness in terms of the operation of a core system and a response to an encrypted packet.

However, the technical goals are not limited to those described above, and other technical goals may be present.

### Technical Solutions

According to an aspect, there is provided a method of controlling a traffic pattern of a user plane, including receiving a request for analytics of abnormal user plane traffic from a consumer network function (NF), collecting data for the analytics of the abnormal user plane traffic from a fifth generation core (5GC) NF, generating analytics information on the abnormal user plane traffic based on the collected data, and transmitting the analytics information to the consumer NF, wherein the analytics information may include one of statistical information and prediction information associated with control of the abnormal user plane traffic.

The consumer NF may be one of a user plane function (UPF), a session management function (SMF), or a policy control function (PCF).

The collected data may include information for identifying an associated application/service data flow, a user equipment (UE) identifier, traffic characteristic information, and user plane pattern information.

The traffic characteristic information may include traffic characteristic information from an SMF or a UPF, and information about characteristics of normal traffic and abnormal traffic collected from an external server or an AF, and information about a type of the abnormal traffic.

The analytics information may include identification information on a traffic flow, a type of abnormal traffic, information on a detected anomaly, a volume of abnormal traffic, a transmission rate, or a burst size, a UPF identifier affected by an identified abnormal traffic type, a user equipment (UE) list, and a protocol data unit (PDU) session list, identifier information on a traffic source, and a time window.

An action on the abnormal user plane traffic may be performed by the consumer NF based on the analytics information.

When the consumer NF is the UPF, an action for downlink traffic suppression may be performed by the UPF.

When the consumer NF is the UPF and subscription initiation follows a subscribe-notify model, the SMF may perform a subscription to the analytics of the abnormal user plane traffic on behalf of the UPF and may specify that a reduced output is requested for the subscription.

According to an aspect, there is provided a server device for controlling a traffic pattern of a user plane, including a processor, and a memory electrically connected to the processor and configured to store instructions executable by the processor, wherein, when the instructions are executed by the processor, the instructions may cause the server device to perform a plurality of operations, and the plurality of operations may include receiving a request for analytics of abnormal user plane traffic from an NF, collecting data for the analytics of the abnormal user plane traffic from a 5GC NF, generating analytics information on the abnormal user plane traffic based on the collected data, and transmitting the analytics information to the consumer NF, wherein the analytics information may include one of statistical information and prediction information associated with control of the abnormal user plane traffic.

The consumer NF may be one of a UPF, an SMF, or a PCF.

The collected data may include information for identifying an associated application/service data flow, a UE identifier, traffic characteristic information, and user plane pattern information.

The traffic characteristic information may include traffic characteristic information from an SMF or a UPF, and information about characteristics of normal traffic and abnormal traffic collected from an external server or an AF, and information about a type of the abnormal traffic.

The analytics information may include identification information on a traffic flow, a type of abnormal traffic, information on a detected anomaly, a volume of abnormal traffic, a transmission rate, or a burst size, information identifying a UPF, a UE list, and a PDU session list affected by an identified abnormal traffic type, identifier information on a traffic source, and a time window.

An action on the abnormal user plane traffic may be performed by the consumer NF based on the analytics information.

When the consumer NF is the UPF, an action for downlink traffic suppression may be performed by the UPF.

When the consumer NF is the UPF and subscription initiation follows a subscribe-notify model, the SMF may perform a subscription to the analytics of the abnormal user plane traffic on behalf of the UPF and may specify that a reduced output is requested for the subscription.

### BRIEF DESCRIPTION OF DRAWINGS

FIG. 1 illustrates a network system according to an embodiment.

FIG. 2 is a diagram illustrating a network data analytics process according to an embodiment.

FIG. 3 is a diagram illustrating an abnormal user plane traffic analysis process according to an embodiment.

FIG. 4 is a flowchart of an example of a method of controlling an abnormal user plane traffic according to an embodiment.

FIG. 5 is a flowchart of another example of a method of controlling an abnormal user plane traffic according to an embodiment.

FIG. 6 illustrates a schematic block diagram of a device according to an embodiment.

### DETAILED DESCRIPTION FOR CARRYING OUT THE INVENTION

The following detailed structural or functional description is provided as an example only and various alterations and modifications may be made to the embodiments. Accordingly, the embodiments are not to be construed as limited to the disclosure and should be understood to include all changes, equivalents, or replacements within the idea and the technical scope of the disclosure.

Although terms of “first,” “second,” and the like are used to explain various components, the components are not limited to such terms. These terms are used only to distinguish one component from another component. For example, a first component may be referred to as a second component, or similarly, the second component may be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

As used herein, the singular forms “a,” “an,” and “the” are intended to include the plural forms as well, unless the context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. It will be understood that the terms “comprises/comprising” and/or “includes/including” when used herein, specify the presence of stated features, integers, steps, operations, elements, components, or groups thereof, but do not preclude the presence or addition of one or more other features, integers, steps, operations, elements, components, or groups thereof.

Unless otherwise defined, all terms, including technical and scientific terms, used herein have the same meaning as commonly understood by one of ordinary skill in the art to which this disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

As used in connection with embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

The term “unit” used herein may refer to a software or hardware component, such as an FPGA or an ASIC, and the “unit” performs predefined functions. However, the term “unit” is not limited to software or hardware. The “unit” may be configured to be in an addressable storage medium or configured to operate one or more processors. For example, the “unit” may include components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, embodiments will be described in detail with reference to the accompanying drawings. When describing the embodiments with reference to the accompanying drawings, like reference numerals refer to like elements and a repeated description related thereto is omitted.

Terms used herein to identify a connection node, to indicate network entities, to indicate messages, to indicate an interface among network entities, to indicate various pieces of identification information are examples for ease of description. Thus, terms are not limited to terms described later in this disclosure and other terms referring to a subject having the equivalent technical meaning may be used.

Herein, for ease of description, of the currently existing communication standards, terms and names defined by long-term evolution (LTE) and new radio (NR) standards, which are the latest standards defined by the third generation partnership project (3GPP) association, are used. However, embodiments described hereinafter are not limited to the terms and names and a system in compliance with other standards may be applicable in the same manner.

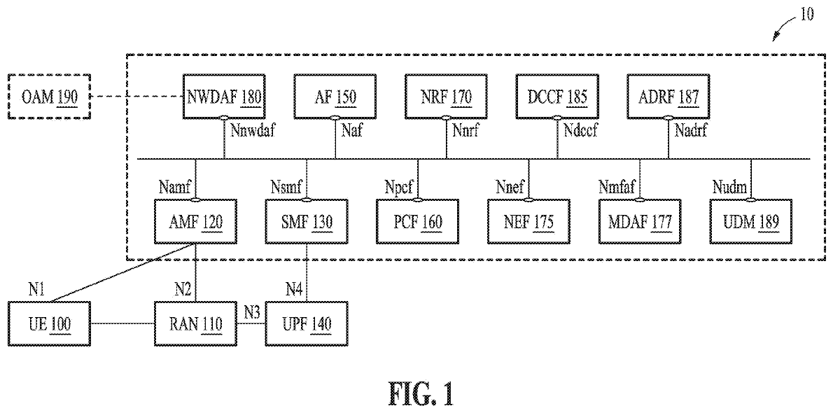

FIG. 1 illustrates a network system according to an embodiment.

Referring to FIG. 1, according to an embodiment, a network system 10 (e.g., a fifth generation (5G) network system, a sixth generation (6G) network system, or a 5G/6G network system) may include a plurality of entities 100 to 190. User equipment (UE) (or a user terminal) 100 may be connected to a 5G core network via a radio access network (RAN) 110. The RAN 110 may refer to a base station that provides a wireless communication function to the UE 100. Operation, administration, and maintenance (OAM) 190 may be a system for managing a terminal and a network.

A unit that each function provided by the network system 10 performs may be defined as a network function (NF). The NF may include an access and mobility management function (AMF) 120, a session management function (SMF) 130, a user plane function (UPF) 140, an application function (AF) 150, a policy control function (PCF) 160, a network repository function (NRF) 170, a network exposure function (NEF) 175, a management data analytics function (MDAF) 177, a network data analytics function (NWDAF) 180, a data collection coordination function (DCCF) 185, an analytics data repository function (ADRF) 187, and a unified data management (UDM) 189. The AMF 120 may manage network access and mobility of a terminal, the SMF 130 may perform a function associated with a session, the UPF 140 may transmit user data, and the AF 150 may communicate with a 5G core (5GC) to provide an application service. The PCF 160 may manage a policy, and the NRF 170 may handle a function to store state information of NFs and process a request to find an accessible NF for other NFs.

The NWDAF 180 may provide an analytics result by analyzing data collected in a network (e.g., a 5G network) to support network automation. The NWDAF 180 may collect, store, and analyze information from the network. The NWDAF 180 may collect information from the OAM 190, an NF (e.g., the AMF 120, the SMF 130, the UPF 140, the PCF 160, the NRF 170, the NEF 175, the MDAF 177, the DCCF 185, the ADRF 187, and/or the UDM 189) constituting a network, the UE, or the AF 150. The NWDAF 180 may provide an analytics result to an unspecified NF (e.g., the AMF 120, the SMF 130, the UPF 140, the PCF 160, the NRF 170, the NEF 175, the MDAF 177, the DCCF 185, the ADRF 187, and/or the UDM 189), the OAM 190, the UE, or the AF 150. The analytics result may be independently used by each NF (e.g., the AMF 120, the SMF 130, the UPF 140, the PCF 160, the NRF 170, the NEF 175, the MDAF 177, the DCCF 185, the ADRF 187, and/or the UDM 189), the OAM 190, the UE, or the AF 150.

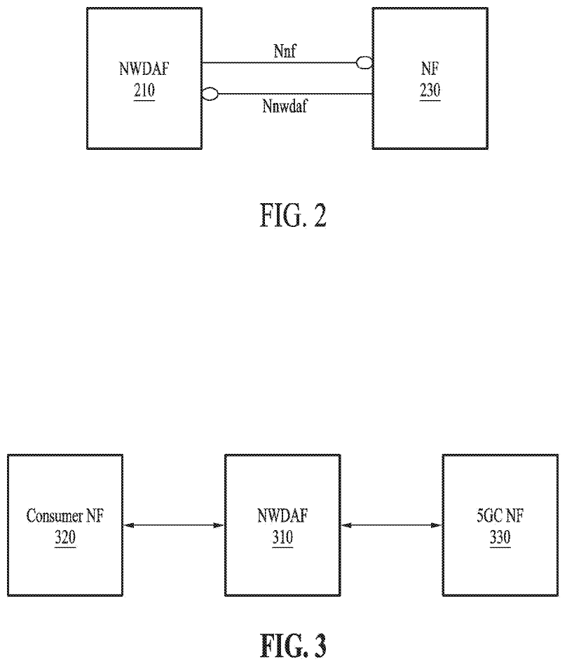

FIG. 2 is a diagram illustrating a network data analytics process according to an embodiment.

An NWDAF 210 (e.g., the NWDAF 180 of FIG. 1) may provide an NWDAF service to an NF 230. The NWDAF service may include a service, such as analytics information subscription (Nnwdaf_AnalyticsSubscription), analytics information requesting (Nnwdaf_AnalyticsInfo), data management (Nnwdaf_DataManagement), machine learning (ML) model provisioning (Nnwdaf_MLModelProvision), ML model information requesting (Nnwdaf_MLModelInfo), ML model monitoring (Nnwdaf_MLModelMonitor), ML model training (Nnwdaf_MLModelTraining), ML model training information requesting (Nnwdaf_MLModelTrainingInfo), and roaming user analytics (Nnwdaf_RoamingAnalytics), and roaming data management (Nnwdaf_RoamingData). The NWDAF service provided by the NWDAF 210 may be shown in Table 1.

TABLE 1

| | Service | Operation | Example |
|---|---|---|---|
| Service Name | Operations | Semantics | Consumer(s) |
| Nnwdaf_ | Subscribe | Subscribe/ | PCF, NSSF, AMF, |
| AnalyticsSubscription | | Notify | SMF, NEF, |
| | | | AF, OAM, |
| | | | CEF, NWDAF, |
| | | | DCCF |
| | Unsubscribe | | PCF, NSSF, AMF, |
| | | | SMF, NEF, |
| | | | AF, OAM, |
| | | | CEF, NWDAF, |
| | | | DCCF |
| | Notify | | PCF, NSSF, AMF, |
| | | | SMF, NEF, |
| | | | AF, OAM, |
| | | | CEF, NWDAF, |
| | | | DCCF, |
| | | | MFAF |
| | Transfer | Request/ | NWDAF |
| | | Response | |
| Nnwdaf_ | Request | Request/ | PCF, NSSF, AMF, |
| AnalyticsInfo | | Response | SMF, NEF, |
| | | | AF, OAM, |
| | | | CEF, NWDAF, |
| | | | DCCF |
| | ContextTransfer | Request | NWDAF |
| | | Response | |
| Nnwdaf_ | Subscribe | Subscribe/ | NWDAF, DCCF |
| DataManagement | Notify | Notify | NWDAF, DCCF, |
| | | | MFAF, ADRF |
| | Fetch | Request/ | NWDAF, DCCF, |
| | | Response | MFAF, ADRF |
| Nnwdaf_ | Subscribe | Subscribe/ | NWDAF |
| MLModelProvision | Unsubscribe | Notify | NWDAF |
| | Notify | | NWDAF |
| Nnwdaf_ | Request | Request/ | NWDAF |
| MLModelInfo | | Response | |
| Nnwdaf_ | Subscribe | Subscribe/ | NWDAF |
| MLModelMonitor | Unsubscribe | Notify | NWDAF |
| | Notify | | NWDAF |
| | Register | Request/ | NWDAF |
| | Request | Response | NWDAF |
| Nnwdaf_ | Subscribe | Subscribe/ | NWDAF |
| MLModelTraining | Unsubscribe | Notify | NWDAF |
| | Notify | | NWDAF |
| Nnwdaf_ | Request | Request/ | NWDAF |
| MLModelTrainingInfo | | Response | |
| Nnwdaf_ | Subscribe | Subscribe/ | H-NWDAF, |
| RoamingAnalytics | Unsubscribe | Notify | V-NWDAF |
| | | | H-NWDAF, |
| | | | V-NWDAF |
| | Notify | | H-NWDAF, |
| | | | V-NWDAF |
| | Request | Request/ | H-NWDAF, |
| | | Response | V-NWDAF |
| Nnwdaf_ | Subscribe | Subscribe/ | H-NWDAF, |
| RoamingData | Unsubscribe | Notify | V-NWDAF |
| | | | H-NWDAF, |
| | | | V-NWDAF |
| | Notify | | H-NWDAF, |
| | | | V-NWDAF |

NOTE 1:
How OAM consumes Nnwdaf services and which Analytics information is relevant is defined in TS 28.550 [7] Annex H and out of the scope of this TS.
NOTE 2:
How CEF consumes Nnwdaf services and which Analytics information is relevant is defined in TS 28.201 [21] and out of the scope of this TS.
NOTE 3:
The Nnwdaf_MLModelProvision service and the Nnwdaf_MLModelInfo service are provided by an NWDAF containing MTLF and consumed by an NWDAF containing AnLF.

The NWDAF 210 may perform analytics in response to a request from the NF 230 and may provide the analytics information (e.g., an analytics result) to the NF 230. The NWDAF 210 may provide the analytics information as shown in Table 2 according to the service described in Table 1.

TABLE 2

| Analytics | | |
|---|---|---|
| Information | Request Description | Response Description |
| Slice Load | Analytics ID: load | Load level provided as number |
| level | level information | of UE registrations and number |
| information | | of PDU sessions for a Network |
| | | Slice and Network |
| | | Slice instances as well as resource |
| | | utilization for Network |
| | | Slice instances. |
| Observed | Analytics ID: | Observed Service experience |
| Service | Service Experience | statistics or predictions may |
| experience | | be provided for a Network Slice |
| information) | | or an Application. They may be |
| | | derived from an individual |
| | | UE, a group of |
| | | UEs or any UE. For slice service |
| | | experience, they may be |
| | | derived from an Application, |
| | | a set of Applications or all |
| | | Applications on the Network Slice. |
| NF Load | Analytics ID: NF | Load statistics or |
| information | load information | predictions information |
| | | for specific NF(s). |
| Network | Analytics ID: | Statistics or predictions on the |
| Performance | Network | load in an Area of Interest; |
| information | Performance | in addition, statistics or |
| | | predictions on the number |
| | | of UEs that are |
| | | located in that Area of Interest. |
| UE mobility | Analytics ID: | Statistics or predictions |
| information | UE Mobility | on UE mobility. |
| | | When visited AOI(s) is included |
| | | in the Analytics Filter information, |
| | | only statistics on UE |
| | | mobility can be provided. |
| UE | Analytics ID: UE | Statistics or predictions on UE |
| Communication | Communication | communication. |
| information | | |
| Expected UE | Analytics ID: UE | Analytics on UE Mobility |
| behavioural | Mobility and/or | and/or UE Communication. |
| parameters | UE Communication | |
| UE Abnormal | Analytics ID: | List of observed or expected |
| behaviour | Abnormal | exceptions, with Exception |
| information | behaviour | ID, Exception Level and other |
| | | information, depending on the |
| | | observed or expected exceptions. |
| E2E data | Analytics | Analytics on E2E data |
| volume | ID: E2E data | volume transfer time. |
| transfer time | volume transfer | |
| | time | |
| User Data | Analytics ID: | Statistics or predictions on the user |
| Congestion | User Data | data congestion for transfer over |
| information | Congestion | the user plane, for transfer over |
| | | the control plane, or for both. |
| QoS | Analytics ID: QoS | For statistics, the information |
| Sustainability | Sustainability | on the location and the |
| | | time for the QoS change |
| | | and the threshold(s) that |
| | | were crossed; or, for predictions, |
| | | the information on the location |
| | | and the time when a potential |
| | | QoS change may occur and what |
| | | threshold(s) may be crossed. |
| Session | Analytics ID: | Statistics on session management |
| Management | Session | congestion control |
| Congestion | Management | experience for specific |
| Control | Congestion Control | DNN and/or S-NSSAI. |
| Experience | Experience | |
| Redundant | Analytics ID: | Statistics or predictions aimed at |
| Transmission | Redundant | supporting redundant transmission |
| Experience | Transmission | decisions for URLLC services. |
| | Experience | |
| WLAN | Analytics ID: | Statistics or predictions on WLAN |
| performance | WLAN | performance of UE. |
| | performance | |
| Dispersion | Analytics ID: | Statistics or predictions that |
| | UE Dispersion | identify the location (i.e. areas |
| | | of interest) or network |
| | | slice(s) where a UE, or a |
| | | group of UEs disperse |
| | | their data volume, or disperse |
| | | mobility or session management |
| | | transactions or both. |
| DN | Analytics ID: | Statistics or predictions on |
| Performance | DN Performance | user plane performance |
| | | for a specific Edge |
| | | Computing application. |
| PFD | Analytics ID: | Statistics on PFD |
| Determination | PFD Determination | information for a known |
| | | application identifier(s). |
| Movement | Analytics ID: | Statistics or predictions on |
| Behavior | Movement | movement behavior for an |
| | Behavior | applicable area |
| Signalling | Analytics ID: | Statistics or predictions on |
| Storm | Signalling storm | controlling signalling storm |
| | | for network abnormal |
| | | behaviour mitigation or |
| | | prevention. |
| Abnormal user | Analytics ID: | Statistics of prediction |
| plane traffic | Abnormal user | on abnormal user |
| | plane traffic | plane traffic control |

For example, in response to a request (e.g., Analytics ID=analysis of “abnormal user plane traffic”) from the NF 230, the NWDAF 210 may analyze the “abnormal user plane traffic” and may provide the NF 230 with the statistics or prediction on abnormal user plane traffic control as the analytics information.

Hereinafter, the analytics subscription service (Nnwdaf_AnalyticsSubscription service) and the analytics information request service (Nnwdaf_AnalyticsInfo service) among the services of Table 1 are further described.

The NWDAF 210 (e.g., the NWDAF 180 of FIG. 1) may provide the analytics information subscription service (Nnwdaf_AnalyticsSubscription service) to the NF 230. The analytics information subscription service may be a service to subscribe to or unsubscribe from network data analytics information (or a network data analytics result) generated by the NWDAF 210. According to the needs of an NF of the NF 230 that subscribes to the service, the analytics information subscription service may be divided into periodically receiving network analytics information (or a network analytics result) or receiving analytics information (or an analytics result) when a predetermined condition is satisfied. The analytics information subscription service may be provided through three operations of subscribing, unsubscribing, and notifying.

The subscription operation (Nnwdaf_AnalyticsSubscription_Subscribe operation) may include a required input and/or an optional input. The required input may include a single network slice selection assistance information (S-NSSAI), an event identifier (ID) or an analytics ID, a notification target address, and an event reporting information. The optional input may include information additionally required for analytics information processing. For example, the optional input may include information about an event filter or an analytics filter (or an analytics information filter). However, the example is not limited thereto.

In the case of subscription cancellation operation (Nnwdaf_AnalyticsSubscription_Unsubscribe operation), the NF 230 may transmit subscription ID information to the NWDAF 180 and the NWDAF 210 may transmit a message notifying confirmation of subscription cancellation to the NF 230 requesting subscription cancellation as an output.

A notification operation (Nnwdaf_AnlayticsSubscription_Notify operation) may be that the NWDAF 210 notifies the NF 230 successfully subscribing to the analytics information subscription service of the network data analytics information (or the network data analytics result) periodically or when a specific condition is satisfied. The notification operation may include an event ID or an analytics ID (or analytics information ID) and a notification target address.

The NWDAF 210 may provide an analytics information request service to the NF 230. Unlike the analytics information subscription service, the analytics information request service may be a service in which the NF 230 requests analytics on predetermined information and receives a result value as soon as the request is completed. An operation of the analytics information request service may include a request and a response. The NF 230 requesting the analytics information may send an analytics information request message (e.g., Nnwdaf_AnalyticsInfo_Request service operation) to the NWDAF 180.

The NWDAF 210 may send the analytics information to each NF 230 requesting the analytics information. The analytics information may be used to optimize the performance of an operation (or a network function) (e.g., congestion control, quality of service (control QoS) management, traffic control, mobility management, load balancing, and power management of a terminal) performed by the NF 230.

The NF 230 (e.g., the UE 100, the RAN 110, the AMF 120, the SMF 130, the UPF 140, the AF 150, the PCF 160, the NRF 170, the NEF 175, the MDAF 177, the DCCF 185, the ADRF 187, and/or the OAM 190 of FIG. 1) may be a consumer NF (or a user NF) that requests an analytics result from the NWDAF 210. The NF 230 may be a service consumer NF of the network data analytics service. The NWDAF 210 may collect data from the NF 230 and analyze the data to generate the analytics information requested by the consumer NF. The NWDAF 210 may transmit the analytics information to the consumer NF that transmits the analytics request. Accordingly, the NWDAF 210 may be a provider NF of the analytics result requested by the consumer NF. The NWDAF 210 may be a service provider NF of a service that provides an analytics information requested by a service consumer NF.

The NWDAF 210 may include at least one of an analytics logical function (AnLF) and a model training logical function (MTLF). The NWDAF 210 may include both an MTLF and an AnLF or may support both.

An NWDAF (e.g., the NWDAF 210) including the AnLF may perform inference and may derive analytics information (e.g., derive statistics and/or prediction in response to an analytics consumer request). The NWDAF including the AnLF may expose a network data analytics service (e.g., Nnwdaf_AnalyticsSubscription or Nnwdaf_AnalyticsInfo).

An NWDAF (e.g., the NWDAF 210) including the MTLF may train a machine learning (ML) model and may expose a new training service (e.g., provide an initial version that is not trained or a trained model).

FIG. 3 is a diagram illustrating an abnormal user plane traffic analysis process according to an embodiment.

An NWDAF 310 (e.g., the NWDAF 180 of FIG. 1 and the NWDAF 210 of FIG. 2) may support analytics for mitigation and prevention of abnormal user plane traffic.

A consumer NF 320 (e.g., the NF 230 of FIG. 2) may send a request for abnormal user plane traffic analytics. The consumer NF 320 may include at least one of the SMF 130, the UPF 140, the AF 150, and/or the PCF 160 of FIG. 1.

The NWDAF 310 may receive a request for abnormal user plane traffic analytics from the consumer NF 320 (e.g., the NF 230 of FIG. 2). The request for abnormal user plane traffic analytics may be analytics information subscription (Nnwdaf_AnalyticsSubscription) or analytics information request (Nnwdaf_AnalyticsInfo).

The NWDAF 310 may collect data for abnormal user plane traffic analytics from a 5GC NF 330. The 5GC NF 330 may include one or more of the UE 100, the RAN 110, the AMF 120, the SMF 130, the UPF 140, the AF 150, the PCF 160, the NRF 170, the NEF 175, the MDAF 177, the DCCF 185, the ADRF 187, and/or the OAM 190 of FIG. 1. When individual UE is an analytics target, the NWDAF 310 may perform a subscription procedure on the SMF 130 to obtain related information from the UPF 140.

For example, the NWDAF 310 may collect the following data.
Information for identifying associated application/service data flow (e.g., packet filter, traffic flow, source and/or destination IP address and port, protocol type, uniform resource locator (URL) list, QFI, application ID).
Identifiers of corresponding UE (terminals).
Traffic characteristic information from the SMF 130 or UPF 140 (e.g., measured uplink (UL)/downlink (DL) data volume, measured UL/DL transmission rate).
User plane pattern information (e.g., pattern types including malformed, unknown, duplicate, and fragmented).
Characteristic information of normal traffic and abnormal traffic collected by external server or AF and type information about abnormal traffic. The NWDAF 310 may compare the characteristics of input traffic with characteristics of normal or abnormal traffic to use the comparison information to identify whether the input traffic is abnormal traffic.

An event subscription performed by the NWDAF 310 on the UPF 140 may target “any UE” or “specific UEs” and may provide information about an abnormal event of the target traffic, a threshold with respect to volume/burst and/or a sampling period. When the NWDAF 310 requests a traffic abnormal report, the UPF 140 may report only when an anomaly of the traffic is detected and exceeds a set threshold.

The NWDAF 310 may generate analytics information about the abnormal user plane traffic based on collected data and may provide the analytics information (e.g., abnormal user plane traffic statistics and/or abnormal user plane traffic prediction) to the consumer NF 320.

An output of the analytics information from the NWDAF 310 may include one or more of the following items.
Identification information of traffic flow (e.g., traffic flow descriptors)
Type of abnormal traffic
Information (e.g., malformed, unexpected traffic volume, and burst) about detected anomaly, such as malicious (e.g., distributed denial of service (DDoS))
Volume of abnormal traffic, transmission rate, or burst size
ID/address of UPF affected by identified abnormal traffic type, interface (if applicable), UE list and protocol data unit (PDU) session list
ID information about traffic source: (e.g., IP packet filter, IP protocol (transmission control protocol (TCP), user datagram protocol (UDP), etc.), application ID, etc.)
Time window (e.g., start time and duration)

The consumer NF 320 may take an action (e.g., an operation for mitigation and/or prevention) based on the analytics information (e.g., abnormal user plane traffic statistics and/or abnormal user plane traffic storm prediction). The operation for mitigation and/or prevention may be based on a policy/configuration of an operator and NF implementation.

When the consumer NF 320 is the SMF 130, the SMF 130 may determine a mitigation action as follows.
Reselect a UPF to distribute load among UPF instances.
The UPF may be configured to perform DL traffic suppression (e.g., selective packet drop or limiting the number of packets per second) or shape abnormal traffic to enforce bandwidth limitation. For each observed traffic anomaly that the NWDAF 310 may report, a corresponding mitigation action may be set to the SMF 130. Thereafter, the SMF 130 may provide it to the UPF 140. In this case, the SMF 130 may use a “non-PDU session level” action that is applicable to all PDU sessions.

When the consumer NF 320 is the UPF 140 and abnormal traffic is detected, the UPF 140 may take the following actions.
DL traffic suppression (e.g., selective packet drop or limiting the transmission rate)
When the UPF 140 is the consumer NF 320, subscription initiation may follow a “Subscribe-Notify” model. In this case, the SMF 130 may subscribe to the NWDAF service with a new analytics ID for an abnormal data packet pattern on behalf of the UPF 140 and may specify that a “reduced output” is requested. Then, the NWDAF 310 may directly transmit the analytics result to the UPF 140 to activate or deactivate a relevant rule for abnormal data packet processing in the UPF 140, and the analytics result?? may include DL traffic suppression (e.g., selective packet drop or limiting the number of packets per second) or adjusting packet processing resources.

The UPF 140 may detect abnormal traffic. When the abnormal traffic is detected, the UPF 140 may take an action to improve user plane performance using N4 rules, such as the existing packet detection rule (PDR), associated QoS enforcement rule (QER), or forwarding action rule (FAR), regardless of the usage of analytics.

When the consumer NF 320 is the PCF 160 and abnormal traffic is detected, the PCF 160 may take the following actions.
Generating or updating a policy and providing the policy to the SMF (e.g., performing traffic gating or shaping, enforcing a bandwidth parameter (e.g., limiting the transmission rate), or adjusting a QoS parameter).

PCF 160 (e.g., an Internet-of-Things (IoT) server) may take an action to correct abnormal traffic.

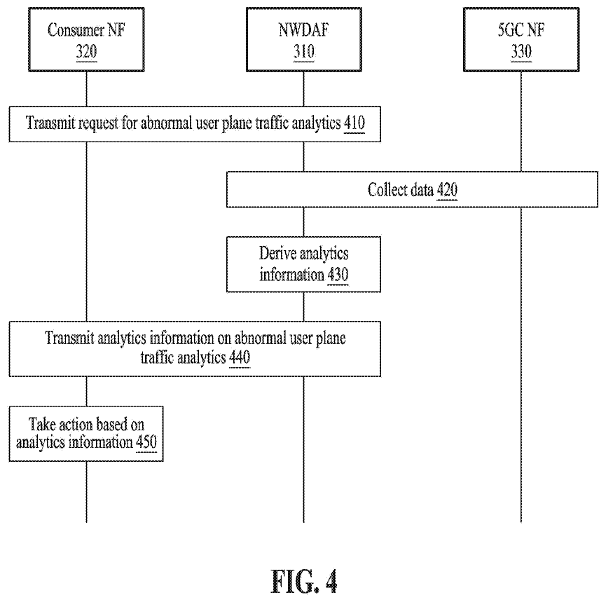

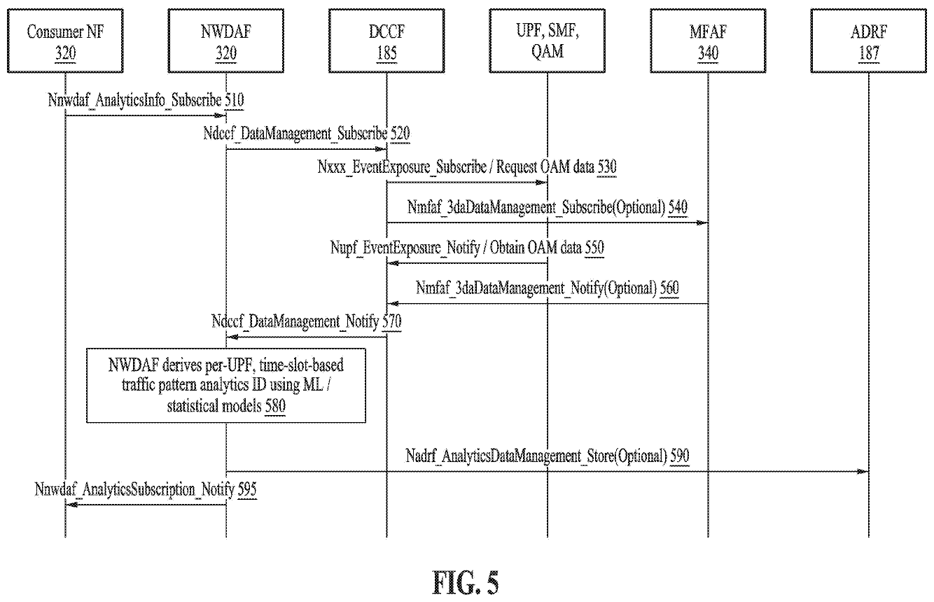

FIG. 4 is a flowchart of an example of a method of controlling an abnormal user plane traffic according to an embodiment.

FIG. 4 may be intended to illustrate a procedure to support mitigation and/or prevention of abnormal user plane traffic. The NWDAF 310 may support mitigation and/or prevention of abnormal user plane traffic by providing analytics information about the abnormal user plane traffic. The NWDAF 310 may improve not only efficient performance of the user plane but also robustness of the UPF by applying a mitigation strategy, such as preventing abnormal or malicious traffic (e.g., malicious traffic) based on the analytics result.

In operation 410, the consumer NF 320 may subscribe to “abnormal user plane traffic” analytics or send a request to the NWDAF 310 using the AnalyticsSubscription_Subscribe or Nnwdaf_AnalyticsInfo_Request service operation. The request may include a threshold, such as a confidence level. The analytics ID may be set to “abnormal user plane traffic” analytics. A target of an analytics report may be set to any UE or UE group. An analytics filter (e.g., Area of Interest (Aol) and/or S-NSSAI and/or deep neural network (DNN), etc.) may be provided to reduce control plane signaling.

The consumer NF 320 may request statistics and/or predictions on a given analytics target period (e.g., a specific analytics target period).

In operation 420, the NWDAF 310 may collect (e.g., retrieve) data from the 5GC NF 330 using an Nnf_EventExposure_Subscribe service operation. The 5GC NF 330 may include one or more of the UE 100, the RAN 110, the AMF 120, the SMF 130, the UPF 140, the AF 150, the PCF 160, the NRF 170, the NEF 175, the MDAF 177, the DCCF 185, the ADRF 187, and/or the OAM 190 of FIG. 1.

For example, the NWDAF 310 may collect data from the UPF 140. Since the UPF 140 processes all UP packets, the UPF 140 may monitor most efficiently according to a packet forwarding control protocol (PFCP) rule and local settings and may collect, generate, and report the data (e.g., user plane (UP) pattern data) to the NWDAF 310 based on observation.

The data (e.g., the UP pattern data) may be a collection of packet information during a measurement period. For example, this may attempt to capture a potential anomaly sign observed locally during the measurement period according to a primitive threshold or rule set by the operator. If at least one anomaly sign is considered to have been detected, relevant information, such as an unexpected flow and packet, may be listed, and relevant application information configured as an n-tuple IP flow may be obtained.

The information may be obtained for each IP flow, and the information may include a total number of packets, volume, directionality, basic statistics, a discarded packet, buffered information along, and resource information of the related UPF.

The data collection from the UPF 140 and/or the SMF 130 may be shown as Table 3.

TABLE 3

| Information | Source | Description |
|---|---|---|
| UE ID | SMF, | Identifier of the UE (e.g. SUPI) |
| | UPF | associated for the UP pattern |
| | | data. |
| UE IP Address | SMF, | UE IP address associated |
| | UPF | for the UP pattern data. |
| S-NSSAI | SMF, | Network Slice. Network Slice |
| | UPF | associated for the UP pattern data. |
| DNN | SMF, | Data Network Name. |
| | UPF | |
| PDU Session ID | SMF | PDU Session identifier. |
| UPF ID | UPF | IP address or fully qualified domain |
| | | name (FQDN) of the UPF |
| UP pattern data | SMF, | User Plane pattern data collection. |
| | UPF | |
| > Measurement | SMF, | The measurement duration for the |
| duration | UPF | UP pattern (timestamp of start |
| | | and end time). |
| > UPF interface | SMF, | Identifier and address of the UPF |
| info | UPF | interface where UP pattern is observed |
| | | (e.g. N3 for RAN side, N6 for DN side). |
| > PFCP session | SMF, | Summary of PFCP session context (e.g. |
| info | UPF | PDR/FAR/QER/URR/BAR) |
| | | status and any PFCP errors per |
| | | clause 7.6 of TS 29.244 [14] for |
| | | the UP pattern. |
| > Delay info | SMF, | Delays observed at N6 (N6 Delay), |
| | UPF | N3/N9 (GTP-U Path), N4 |
| | | (PFCP HB) Interface per clauses |
| | | 5.33.8, 5.24.5, 6.2.2 of |
| | | TS 29.244 [14] for the pattern. |
| > Sampled info | UPF | Information related to the traffic |
| | | sample rate, if sampling is used. |
| > Anomaly info | UPF | List of any anomalies locally |
| (0 . . . max) | | observed for the UP pattern during |
| | | the measurement period based |
| | | on thresholds or rules configured |
| | | by operator at UPF (each entry |
| | | describes one anomaly |
| | | observation). |
| >> Unexpected | UPF | Anomaly information regarding |
| flow info | | a traffic persisting unusually |
| | | long/sort or at very high/low |
| | | throughput relative to expected |
| | | usage patterns. For examples, |
| | | Long duration >60 secs, Short |
| | | duration: <1 sec, High rate: |
| | | >5000 pps, Slow rate: <0.1 pps. |
| | | It can also be a high/low frequency |
| | | of new application traffic |
| | | initiations or service access attempts |
| | | by the UE's application or |
| | | application server, e.g. DDoS |
| | | behaviour, unexpected traffic |
| | | access outside of its normal usage. |
| >> Unexpected | UPF | Anomaly information regarding |
| packet info | | traffic targeting an unexpected or |
| | | unauthorized packet address |
| | | (e.g. IP, protocol, port, prefix, |
| | | domain) and packet string |
| | | (e.g. headers, fields, sizes, |
| | | malformed, duplicates, unknown, |
| | | fragmented). |
| > Application traffic | UPF | List of observed Application traffic |
| info (1 . . . max) | | information communicating |
| | | with the UE based on thresholds |
| | | or rules configured by operator |
| | | at UPF (each entry describes |
| | | one flow observation). |
| >> Per-flow info | UPF | IP flow represented and aggregated |
| | | by n-tuples, e.g. SrcIP, |
| | | DstIP, SrcPort, DstPort, Protocol, |
| | | uni/bi-directionality, URL, total |
| | | number of packets, their total |
| | | volume in size and duration. This |
| | | also implies the address of the |
| | | application server which have |
| | | communicated with the UPF. |
| >> Per-flow stats | UPF | Quartiles and statistics such as |
| info | | average packet size. |
| >> Per-flow | UPF | Discarded packets including |
| discarded packet | | total number of packets, discarded |
| info | | reasons. |
| >> Per-flow | UPF | Buffered or queued packets |
| buffered info | | including total number of buffered |
| | | packets, average buffered time, |
| | | buffered reasons. |
| >> Per-flow | UPF | Temporal packet behaviour |
| temporal behaviour | | including inter arrival time, jitter, |
| | | latency related information. |
| >> Per-flow | UPF | Resources related to load, |
| resource info | | e.g. CPU, Memory, Energy, |
| | | processing delay, associated |
| | | for processing the flow. |
| >> Syn-Ack | UPF | Measured syn-ack signalling |
| signalling info | | characteristic of an application |
| | | traffic communicating with the |
| | | UE's application, e.g. number of |
| | | syn-ack packets. |
| >> SSL/TLS | UPF | Calculated SSL/TLS fingerprint |
| fingerprint | | of an encrypted connection of the |
| | | traffic flow between the UE |
| | | and application. |

The data collection from the AF 150 may be shown as Table 4.

TABLE 4

| Information | Source | Description |
|---|---|---|
| UE address distribution | AF | For a specific application, |
| | | the UE address has |
| | | traffic flow with the application. |
| Normal SSL/TLS | AF | SSL/TLS fingerprints |
| fingerprint | | of normal traffic flow |
| | | communicated with the AS. |
| Average and variance | AF | The average and variance |
| of the number of UE | | of the number of UE |
| communicated with | | communicated with the |
| the AS | | same AS in a time window. |
| Traffic pattern Information | AF | Indicates the traffic |
| (1 . . . max) | | characteristics of different traffic |
| | | patterns. |
| > Traffic flow filter | | Identifies the traffic flow |
| information | | from the DN, e.g. |
| | | application identifier, or |
| | | packet filter set as defined |
| | | in TS 23.501 [2]. |
| > Traffic life-time | | The average duration of |
| (or valid period) | | the traffic flow. |
| > UL data rate | | UL data rate of this traffic flow. |
| > DL data rate | | DL data rate of this traffic flow. |
| > Maximum burst size | | Maximum data burst volume |
| | | of the traffic flow. |
| > Burst periodicity | | Average burst periodicity |
| | | of the traffic flow. |

NOTE 1:
Alternatively, NWDAF can have above information by configuration.

In operation 430, the NWDAF 310 may derive a required analytics result based on the collected data.

In operation 440, the NWDAF 310 may transmit the analytics result (e.g., an output data analytics result) to the consumer NF 320. For example, the NWDAF 310 may invoke Nnwdaf_AnalyticsSubscription_Notify or may transmit Nnwdaf_AnalyticsInfo_Request as a response.

The analytics result (e.g., the prediction and/or statistics) may include severity or a risk level with respect to an expected data anomaly sign. In addition, the analytics result (e.g., the prediction and/or statistics) may include a list of predicted anomaly signs of the data. Each anomaly sign may include a pattern type. The pattern type may include DDoS, burst, overload types (e.g., interface queue full in 5 seconds).

The analytics result (e.g., output analytics) may include information about which application triggers the predicted anomaly sign.

The load of control plane NFs may need to be monitored, and resource allocation and a threshold for the analytics thereof may be set. The resource allocation and threshold settings may include items, such as an analytics filter and the maximum number of anomaly signs of the UP pattern data. An example thereof may be receiving only a report threshold and/or the top N most severe anomaly signs.

An example of the analytics result (e.g., statistics) may be shown as Table 5.

TABLE 5

| Information | Description |
|---|---|
| Time slot entry | List of time slots during the Analytics |
| (1 . . . max) | target period. |
| > Time slot start (or | Time slot start within the |
| time slot start time) | Analytics target period. |
| > Duration | Duration of the time slot. |
| > Severity | Identified severity/risk level, |
| | e.g. Information, Warning, High, |
| | Critical. |
| > UPF ID | Identified UPF ID. |
| > Pattern info | Identified whether the traffic type |
| (0 . . . max) | is normal or abnormal and if |
| | abnormal list of detected anomalies |
| | analysed in the UP pattern |
| | data, each entry describes one |
| | identified anomalies analysed. |
| >> UP pattern type | UP pattern type, e.g. DDOS, |
| | misbehaving server/UE, burst, |
| | malformed packets, unknown |
| | packets, duplicate packets, |
| | fragmented packets, etc. |
| >> Overload type | Detected overloads, e.g. CPU |
| | overloaded, NIC queue full, etc. |
| >> Application traffic | Identified list of detected Application |
| info (0 . . . max) | traffic information in the UP |
| | pattern data. |
| >>> IP packet filter set | IP packet filter set. |

An example of the analytics result (e.g., prediction) may be shown as Table 6.

TABLE 6

| Information | Description |
|---|---|
| Time slot entry | List of time slots during the |
| (1. . . max) | Analytics target period. |
| > Time slot start (or | Time slot start within the |
| time slot start time) | Analytics target period. |
| > Duration | Duration of the time slot. |
| > UPF ID | Identified UPF ID. |
| > Predicted severity | Predicted severity/risk level, e.g. |
| | Informative, Warning, High, |
| | Critical. |
| > Predicted | Predicted whether the traffic type |
| Pattern info | is normal or abnormal and if |
| (0 . . . max) | abnormal list of detected anomalies |
| | analysed in the UP pattern |
| | data, each entry describes one |
| | identified anomalies analysed. |
| >> UP pattern type | Predicted UP pattern type, e.g. |
| | DDoS, misbehaving server/UE, |
| | burst, malformed packets, unknown |
| | packets, duplicate packets, |
| | fragmented packets, etc. |
| >> Overload type | Predicted overloads, e.g. CPU |
| | overloads in 20 s, queue full in 5 s, etc. |
| >> Predicted application | Predicted list of Application traffic |
| traffic info (0 . . . max) | information in the UP pattern |
| | data. |
| >>> IP packet filter set | IP packet filter set. |
| > Confidence | Confidence of this prediction. |

In operation 450, the consumer NF 320 may execute (or perform) an action based on the analytics result (e.g., statistics and/or predictions). Table 7 may show an example of the action.

TABLE 7

| Consumer | Example of actions |
|---|---|
| SMF | Instruct the UPF for: |
| | Buffering Action Rule (BAR) adjustment |
| | (e.g., adjust Downlink Data Report |
| | messages delay, queue and buffering size.) |
| | Selective packet drops e.g. anomaly packet(s). |
| | Overload controls, e.g. reduce UPF load. |
| | Re-selections, e.g. to less loaded UPF. |
| | Traffic suppression, e.g. interface pps thresholds. |
| | PDR resources, e.g. load balancing. |
| | (e.g. based on N4 rules during the traffic life time.) |
| PCF | Generates or updates the PCC rules |
| | which includes the filter of abnormal |
| | traffic and sends it to the SMF. The |
| | created or updated PCC rules may |
| | indicate to drop packet from the abnormal |
| | traffic filter (e.g. change the gate status |
| | of the abnormal traffic to close) or degrade |
| | the QoS level of the abnormal traffic filter |
| | (e.g. modify the 5QI or limit the DL-MBR of the |
| | abnormal traffic) during the traffic life time. |
| UPF | Apply operator-configured policies |
| | (e.g. drop, rate-limit, deny), adjust |
| | packet processing resources, mirror |
| | suspicious/attack/fraud/phishing |
| | packets for security audits, and/or regard |
| | as error/partial failure to trigger UPF-initiated |
| | PFCP Session Release per clause 5.18.2 of |
| | TS 29.244 [14]. |

The UPF 140 may take a mitigation action that is not related to a session/QoS as set by the operator.

The mitigation action of the UPF 140 based on the analytics may not be prioritized over the control of SMF 130/PCF 160, and PDU session cancel and/or UP connection deactivation may be initiated by the SMF 130.

The UPF 140 may report the result to the SMF 130 via a PFCP usage report based on an usage reporting rule (URR) trigger (e.g., a dropped DL traffic threshold) and may also report to the OAM 190 according to the configuration.

FIG. 5 is a flowchart of another example of a method of controlling an abnormal user plane traffic according to an embodiment.

Since some user plane traffic (e.g., loT, a live video, and an encrypted flow) may be bursty or irregular, a static rule, such as a PDR and a QER, may be insufficient. Encrypted traffic (e.g., Quick UDP Internet Connections (QUIC) and Transport Layer Security (TLS)) may limit deep packet inspection (DPI)-based classification, and this may potentially lead to QoS mismatch or inefficiency in UPF resource allocation. A static DL data report (DLDR) (e.g., defined in TS 29.244) or shaping configuration may cause packet loss or a delay in a dynamic traffic condition.

FIG. 5 may be intended to illustrate an example of allowing anomaly detection if necessary while supporting analytics of a user plane traffic pattern and enabling dynamic QoS adaptation.

The NWDAF 310 may collect traffic indicators from the UPF 140, the SMF 130, and the OAM 190 via the DCCF 185, and optionally, a messaging framework adaptor function (MFAF) 340 may mediate the traffic indicators. Data may include flow-level metrics. The flow-level metrics may include a packet rate, burstiness, flow stability, a drop cause, protocol information, and QoS alignment context.

An example of the collected data may be shown in Table 8.

TABLE 8

| Information | Source | Description |
|---|---|---|
| UE IP Address | SMF, UPF | IP address assigned to the UE, |
| | | used to associate traffic flows. |
| SUPI (within PDI) | SMF, UPF | Subscription Permanent Identifier |
| | | in the Packet Detection Information, |
| | | uniquely identifying the UE. |
| DL TEID | UPF | Downlink Tunnel Endpoint |
| | | Identifier used in GTP-U for |
| | | packet forwarding. |
| N6 DL Packet Info | UPF | Contains source/destination |
| (5-tuple + header) | | IP addresses, ports and |
| | | protocol. Application-layer |
| | | headers may be available |
| | | depending on encryption. |
| Packet Count | UPF, OAM | Number of packets observed |
| (UL/DL, N3/N6) | | on N3 and N6 interfaces, |
| | | for uplink and downlink. |
| 5QI, QFI, ARP) | SMF, UPF | Parameters used to define |
| (QoS Flow Info | | QoS characteristics of each |
| (5Q1, QFI, ARP) | | flow. |
| QER Info (GBR, | UPF | QoS Enforcement Rule settings |
| shaping, discard, | | such as guaranteed bit |
| buffering) | | rate, shaping behaviour, discard |
| | | handling and buffer use. |
| FAR/BAR | UPF, SMF | PFCP rules used to forward |
| | | or buffer packets as per |
| | | session context. |
| DL Usage Threshold | SMF, UPF | Triggered when downlink |
| Crossing | | usage exceeds a threshold; |
| | | may help detect bursty flows. |
| Flow End | SMF, UPF | Marks the termination of a |
| | | flow; used for resource |
| | | release or analytics. |
| Congestion | SMF, UPF | May be inferred from queue |
| Notification | | depth or packet drops. |
| UL/DL Volume, | UPF, OAM | Total traffic volume and session |
| Duration | | duration per direction. |
| Jitter | OAM, UPF | Variation in packet arrival |
| | | delay. Can be derived per |
| | | TS 29.244 [14], depending |
| | | on implementation. |
| UE Registration/ | AMF | Indicates whether the UE is |
| Mobility State | | registered, idle, connected, |
| | | or suspended. |
| Paging Event Count | AMF, OAM | Number or frequency of paging |
| | | events observed for the UE. |
| Packet drop cause | UPF, SMF | Indicates why packets were |
| | | dropped (e.g. invalid header, |
| | | unknown dest). |
| UPF load | UPF, OAM, | CPU usage, buffer depth, or |
| | NRF | throughput metrics indicating load. |
| Malformed packet | OAM, UPF | Number of packets dropped |
| count | | or flagged due to protocol |
| | | violations (e.g. invalid headers, |
| | | checksum errors). |

The NWDAF 310 may process the data using an artificial intelligence (AI)/ML model or a statistical algorithm and may generate an analytics result (e.g., output analytics) structured in time slots. Each time slot may include a per-UPF analytics result with respect to pieces of UE and an application flow. The analytics result may include a flow stability indicator, protocol-level insights, a predicted idle behavior, an abnormal packet indicator, and confidence.

The analytics result (e.g., an analytics output) may be shown as Table 9.

TABLE 9

| Information | Description |
|---|---|
| Time slot entry | List of time slots during the |
| (1 . . . max) | Analytics evaluation period. |
| > Time slot start | Start of the slot. |
| > Duration | Duration of the slot. |
| > Per-UPF analytics | Analytics generated per UPF |
| (1. . . max) | per time slot. |
| >> UPF ID | Identified UPF (NF Instance ID or IP). |
| >> Application info | Application ID, FQDN (e.g. video_ |
| | server.example.com), or IP. |
| >> UE ID | SUPI/GPSI associated with flow. |
| >> Transport protocol | Transport-layer protocol observed |
| | in the flow, e.g. TCP, UDP, |
| | QUIC. |
| >> Abnormal packet | Indicates whether unclassified, |
| indicator | malformed, or suspicious |
| | packet flows were detected during |
| | the slot. Value: Yes/No. |
| >> Traffic burst index | Categorized burstiness level of |
| | the traffic pattern: High/ |
| | Medium/Low. |
| >> Flow stability score | Indicates how consistent the |
| | traffic is over time: Stable/ |
| | Medium/Unstable. |
| >> Idle state prediction | Likelihood that the session may |
| | enter an idle state, useful for |
| | DLDR tuning: High/Medium/Low. |
| >> QoS suitability | Indicates whether the currently |
| indicator | assigned QoS parameters |
| | (e.g. 5QI, QER, ARP) appear |
| | suitable for the flow, based on |
| | observable metrics such as |
| | packet size, inter-arrival time and |
| | burst level. This is an estimation |
| | and does not rely on DPI. |
| | Values: Suitable/Uncertain/Unsuitable. |
| >> Policy-related field | Relevant QoS control field that |
| | may be reviewed by the |
| | consumer NF (e.g. QER, DLDR, FAR). |
| >> Timestamp of | The time at which the traffic |
| observation | observation or prediction applies. |
| >> Confidence | Confidence level (if prediction applied). |

An action may be executed (or performed) based on the consumer NF 310. Table 10 may show an example of the action.

TABLE 10

| Consumer NF | Typical Use of NWDAF Analytics |
|---|---|
| SMF | May use traffic behaviour analytics (e.g. |
| | burstiness, idle prediction, abnormal flow |
| | indicators) to optimize UPF handling. |
| | This includes adjusting DLDR timers, |
| | updating FAR configurations, or triggering |
| | path reassessment based on |
| | operator policy. |
| PCF | May interpret traffic indicators to revise |
| | PCC rules, adjust QER shaping levels, or |
| | deprioritize flows when traffic does not align |
| | with QoS expectations. Policy-driven |
| | mitigation actions may be |
| | considered for abnormal or unclassified traffic. |

Based on traffic analytics or an anomaly sign flag, the PCF 160 may reassess or adjust a QER, 5G QoS Identifier (5QI) allocation, a shaping profile, or a DLDR configuration via a Policy and Charging Control (PCC) rule.

When burstiness, idle prediction, or QoS profile mismatch (e.g., 5QI mismatch) occurs, the SMF 130 may modify the FAR, may reassess a forwarding behavior, or may update a UP path configuration.

The NWDAF 310 may not directly control a policy or a forwarding logic. The consumer NF 320 may interpret and apply the analytics result according to the operator policy.

Hereinafter, another example of a method of controlling abnormal user plane traffic is described with reference to FIG. 5.

In operation 510, the consumer NF 320 (e.g., the SMF or PCF) may transmit an Nnwdaf_AnalyticsSubscription_Subscribe request to the NWDAF 310 to subscribe to abnormal user plane traffic analytics (e.g., a burst level, flow stability, and idle prediction).

In operation 520, when receiving the subscription, the NWDAF 310 may determine required data and may request a subscription to the DCCF 185 using Ndccf_DataManagement_Subscribe. This message (e.g., the request) may instruct the DCCF 185 to adjust data collection from an appropriate source NF.

In operation 530, the DCCF 185 may transmit a subscription request to data generation NFs, such as the UPF 140, the SMF 130, and the OAM 190, using Nupf_EventExposure_Subscribe or Nsmf_EventExposure_Subscribe according to the nature of the data (e.g., flow statistics, session information, and Key Performance Indicator (KPI)).

In operation 540, when a direct Service-Based Interface (SBI) subscription is not available (e.g., due to protocol mismatch or legacy system), the DCCF 185 may use the MFAF 340 to mediate data subscription using Nmfaf_3daDataManagement_Subscribe. In other words, the DCCF 185 may mediate the data subscription via the MFAF 340.

In operation 550, the subscribed source NF and the OAM 190 may start transmitting a report (e.g., a report) to the DCCF 185 using Nupf_EventExposure_Notify and Nsmf_EventExposure_Notify.

In operation 560, when the MFAF 340 is used, the MFAF 340 may transmit the data received via Nmfaf_3daDataManagement_Notify to the DCCF 185.

In operation 570, the DCCF 185 may collect or filter the collected data as needed and may transmit the data to the NWDAF 310 via Ndccf_DataManagement_Notify.

In operation 580, an NWDAF 310 may process the collected data and may derive per UPF and time slot-based traffic behavior analytics (or a traffic behavior analytics result) (e.g., a burst level, idle probability, and QoS match) by invoking a trained internal ML model if necessary. A new analytics ID may be allocated to indicate a computed analytics set.

In operation 590, the analytics result (e.g., the analytics output) may be selectively stored in the ADRF 187 via Nadrf_AnalyticsDataManagement_Store for reuse or historical analysis.

In operation 595, the NWDAF 310 may transmit a structured analytics result (e.g., the analytics output) to the subscribed consumer NF 320.

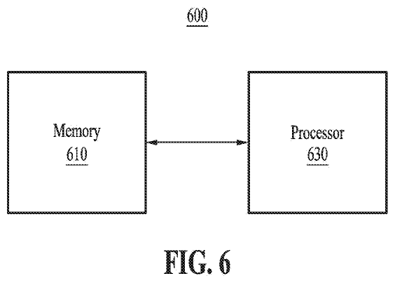

FIG. 6 illustrates a schematic block diagram of a device according to an embodiment.

Referring to FIG. 6, according to an embodiment, a device 600 (e.g., a server device) may be substantially the same as the consumer NF (e.g., the consumer NF 320 of FIG. 3) and/or the NWDAF (e.g., the NWDAF 180 of FIG. 1, the NWDAF 210 of FIG. 2, and the NWDAF 310 of FIG. 3) described with reference to FIGS. 1 to 5. The device 600 may include a memory 610 and a processor 630.

The memory 610 may store instructions (e.g., programs) executable by the processor 530. For example, the instructions may include instructions for performing the operation of the processor 630 and/or the operation of each component of the processor 630.

The memory 610 may be implemented as volatile memory device or non-volatile memory device. The volatile memory device may be implemented as dynamic random-access memory (DRAM), static random-access memory (SRAM), thyristor RAM (T-RAM), zero capacitor RAM (Z-RAM), or twin transistor RAM (TTRAM). The non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase change RAM (PRAM), resistive RAM (RRAM), nanotube RRAM, polymer RAM (PoRAM), nano floating gate memory (NFGM), holographic memory, a molecular electronic memory device, and or insulator resistance change memory.

The processor 630 may execute computer-readable code (e.g., software) stored in the memory 610 and instructions triggered by the processor 630. The processor 630 may be a hardware-implemented data processing device having a circuit that is physically structured to execute desired operations. The desired operations may include, for example, code or instructions included in a program. The hardware-implemented data processing device may include a microprocessor, a central processing unit (CPU), a processor core, a multi-core processor, a multiprocessor, an application-specific integrated circuit (ASIC), and/or a field-programmable gate array (FPGA).

The operation performed by the processor 630 may be substantially the same as the operation of the consumer NF (e.g., the consumer NF 320 of FIG. 3) and/or the NWDAF (e.g., the NWDAF 180 of FIG. 1, the NWDAF 210 of FIG. 2, and the NWDAF 310 of FIG. 3) described with reference to FIGS. 1 to 5. Accordingly, a detailed description thereof is omitted.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, an FPGA, a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording media.

The method according to the embodiments described above may be recorded in non-transitory computer-readable storage media including program instructions to implement various operations of the embodiments described above. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

As described above, although the examples have been described with reference to the limited drawings, one of ordinary skill in the art may apply various technical modifications and variations based thereon. For example, suitable results may be achieved if the described techniques are performed in a different order, and/or if components in a described system, architecture, device, or circuitry are combined in a different manner, or replaced or supplemented by other components or their equivalents.

Therefore, other implementations, other embodiments, and equivalents to the claims are also within the scope of the following claims.

1. A method of controlling a traffic pattern in a user plane, the method comprising:
Receiving, from a consumer network function (NF), a request for analytics of abnormal user plane traffic;
collecting data for the analytics of the abnormal user plane traffic from a fifth generation core (5GC) NF;
generating analytics information on the abnormal user plane traffic based on the collected data; and
transmitting the analytics information to the consumer NF,
wherein the analytics information comprises one of statistical information and prediction information associated with control of the abnormal user plane traffic.

2. The method of claim 1, wherein the consumer NF is one of a user plane function (UPF), a session management function (SMF), or a policy control function (PCF).

3. The method of claim 1, wherein the collected data comprises:
information for identifying an associated application/service data flow;
a user equipment (UE) identifier;
traffic characteristic information; and
user plane pattern information.

4. The method of claim 3, wherein the traffic characteristic information comprises:
traffic characteristic information from a session management function (SMF) or a user plane function (UPF); and
information about characteristics of normal traffic and abnormal traffic collected from an external server or an AF, and information about a type of the abnormal traffic.

5. The method of claim 1, wherein the analytics information comprises:
identification information on a traffic flow;
a type of abnormal traffic;
information on a detected anomaly;
a volume of abnormal traffic, a transmission rate, or a burst size;
information identifying a user plane function (UPF), a user equipment (UE) list, and a protocol data unit (PDU) session list affected by an identified abnormal traffic type;
identifier information on a traffic source; and
a time window.

6. The method of claim 2, wherein an action on the abnormal user plane traffic is performed by the consumer NF based on the analytics information.

7. The method of claim 6, wherein, when the consumer NF is the UPF, an action for downlink traffic suppression is performed by the UPF.

8. The method of claim 2, wherein, when the consumer NF is the UPF and subscription initiation follows a subscribe-notify model, the SMF performs a subscription to the analytics of the abnormal user plane traffic on behalf the UPF and specifies that a reduced output is requested for the subscription.

9. A server device for controlling a traffic pattern in a user plane, the server device comprising:
a processor; and
a memory electrically connected to the processor and configured to store instructions executable by the processor,
wherein, when the instructions are executed by the processor, the instructions cause the server device to perform a plurality of operations, and
the plurality of operations comprises:
receiving a request for analytics of abnormal user plane traffic from a consumer network function (NF);
collecting data for the analytics of the abnormal user plane traffic from a fifth generation core (5GC) NF;
generating analytics information on the abnormal user plane traffic based on the collected data; and
transmitting the analytics information to the consumer NF,
wherein the analytics information comprises one of statistical information and prediction information associated with control of the abnormal user plane traffic.

10. The server device of claim 9, wherein the consumer NF is one of a user plane function (UPF), a session management function (SMF), or a policy control function (PCF).

11. The server device of claim 9, wherein the collected data comprises:
information for identifying an associated application/service data flow;
a user equipment (UE) identifier;
traffic characteristic information; and
user plane pattern information.

12. The server device of claim 11, wherein the traffic characteristic information comprises:
traffic characteristic information from a session management function (SMF) or a user plane function (UPF); and
information about characteristics of normal traffic and abnormal traffic collected from an external server or an AF, and information about a type of the abnormal traffic.

13. The server device of claim 9, wherein the analytics information comprises:
identification information on a traffic flow;
a type of abnormal traffic;
information on a detected anomaly;
a volume of abnormal traffic, a transmission rate, or a burst size;
information identifying a user plane function (UPF), a user equipment (UE) list, and a protocol data unit (PDU) session list affected by an identified abnormal traffic type;
identifier information on a traffic source; and
a time window.

14. The server device of claim 10, wherein an action on the abnormal user plane traffic is performed by the consumer NF based on the analytics information.

15. The server device of claim 14, wherein, when the consumer NF is the UPF, an action for downlink traffic suppression is performed by the UPF.

16. The server device of claim 10, wherein, when the consumer NF is the UPF and subscription initiation follows a subscribe-notify model, the SMF performs a subscription to the analytics of the abnormal user plane traffic on behalf of the UPF and specifies that a reduced output is requested for the subscription.
